(19) United States
(12) Patent Application Publication
(10) Pub. No.: US 2025/0155842 A1
(43) Pub. Date: May 15, 2025

(54) IMAGE FORMING SYSTEM AND PRINTING METHOD FOR IMAGE FORMING SYSTEM

(71) Applicant: Konica Minolta, Inc., Tokyo (JP)

(72) Inventor: Yuji UCHIDA, Tokyo (JP)

(21) Appl. No.: 18/930,562

(22) Filed: Oct. 29, 2024

(30) Foreign Application Priority Data
Nov. 10, 2023 (JP) 2023-192057

(51) Int. Cl. G03G 15/00; G03G 15/23

(52) U.S. Cl. CPC G03G 15/5095; G03G 15/234; G03G 15/5062; G03G 15/6582; G03G 2215/00721; G03G 2215/00734; G03G 2215/047

(57) ABSTRACT

An image forming system includes: a sheet feeder that feeds a sheet; a conveyor that conveys the sheet through a conveyance path; an acquirer that acquires information on an actual size of the sheet; an image former that forms an image on the sheet conveyed through the conveyance path; and a hardware processor, in which the hardware processor controls a first process on the basis of the actual size acquired by the acquirer, the first process being controlled based on an end of the sheet separately from image formation based on a print job.

### CROSS-REFERENCE TO RELATED APPLICATION

The entire disclosure of Japanese patent application No. 2023-192057, filed on Nov. 10, 2023, is incorporated herein by reference in its entirety.

### BACKGROUND OF THE INVENTION

### 1. Technical Field

The present invention relates to an image forming system and a printing method for the image forming system.

### 2. Description of Related Art

In an image forming apparatus, there is a technique for detecting the size of a sheet and correcting an image in accordance with the detected size (for example, Patent Literature 1 (Japanese Unexamined Patent Application Publication No. 2014-238544) and Patent Literature 2 (Japanese Unexamined Patent Application Publication No. 2023-42213). For example, in the image forming apparatus disclosed in Patent Literature 1, a size measuring section is disposed at a position sufficiently upstream of an image former, so that the correction for image position set based on the measurement result of the size measuring section is reflected on the detected sheet.

### SUMMARY OF THE INVENTION

However, the techniques disclosed in Patent Literature 1 and 2 correct the position of image formation based on a print job according to the detected sheet size, and do not consider processing other than image formation.

The present invention has been made in view of the above-described circumstances, and an object of the present invention is to control a first process other than image formation, the first process being controlled based on the end of a sheet.

To achieve at least one of the abovementioned objects, according to an aspect of the present invention, a system reflecting one aspect of the present inventions comprises the followings.

An image forming system including:
a sheet feeder that feeds a sheet;
a conveyor that conveys the sheet through a conveyance path;
an acquirer that acquires information on an actual size of the sheet;
an image former that forms an image on the sheet conveyed through the conveyance path; and
a controller that controls at least one of the sheet feeder, the conveyor, the acquirer, and the image former, wherein
the controller controls a first process on the basis of the actual size acquired by the acquirer, the first process being controlled based on an end of the sheet separately from image formation based on a print job.

### BRIEF DESCRIPTION OF THE DRAWINGS

The advantages and features provided by one or more embodiments of the present invention will be more fully understood from the following detailed description and the accompanying drawings. However, these are for purposes of illustration only and are not intended to limit the present invention.

FIG. 1 is a diagram illustrating a schematic configuration of an image forming system according to the present embodiment;

FIG. 2 is a block diagram illustrating a hardware configuration of an image forming system;

FIG. 3 is a schematic diagram for describing an actual sheet size and a document image size;

FIG. 4 is a schematic diagram illustrating a printing state in a case where the actual sheet size and the document image size are the same;

FIG. 5A is a schematic diagram illustrating image formation control in a case where an actual sheet size is larger than a document image size;

FIG. 5B is a schematic diagram illustrating image formation control in a case where an actual sheet size is larger than a document image size;

FIG. 5C is a schematic diagram illustrating position correction of an additional image in a case where an actual sheet size is larger than a document image size;

FIG. 5D is a schematic diagram illustrating position correction for post-processing in a case where an actual sheet size is larger than a document image size;

FIG. 6A is a schematic diagram illustrating image formation control in a case where an actual sheet size is smaller than a document image size;

FIG. 6B is a schematic diagram illustrating image formation control in a case where an actual sheet size is smaller than a document image size;

FIG. 6C is a schematic diagram illustrating position correction of an additional image in a case where an actual sheet size is smaller than a document image size;

FIG. 6D is a schematic diagram illustrating position correction for post-processing in a case where an actual sheet size is smaller than a document image size;

FIG. 7 is a schematic diagram illustrating a configuration of a conveyance path around an image former;

FIG. 8 is a schematic diagram for describing timing control of image formation;

FIG. 9 is a schematic diagram illustrating image formation control in a case where the shape of the sheet is trapezoidal;

FIG. 10 is a flowchart illustrating printing processing according to the first embodiment;

FIG. 11 is a flowchart illustrating printing processing according to a second embodiment; and

FIG. 12 is a diagram illustrating a schematic configuration of an image forming system in a modification example.

### DETAILED DESCRIPTION

Embodiments of the present invention will be described hereinafter with reference to the accompanying drawings. It is to be noted that the scope of the present invention is not limited to the embodiments to be described. Note that in the description of the drawings, the same components are denoted by the same reference signs, and redundant descriptions will not be repeated. In addition, dimensional ratios in the drawings are exaggerated for convenience of description and may be different from actual ratios. In the present embodiment, the sheet includes a printing sheet (hereinafter simply referred to as sheet) and various films. Hereinafter, the sheet size refers to the size of a sheet set in a sheet feed tray through an operation panel or the like. The actual size refers to the size of a sheet detected by reading of a reader 61 described later. The size of a document image refers to the size of the document image (page print data) included in a print job.

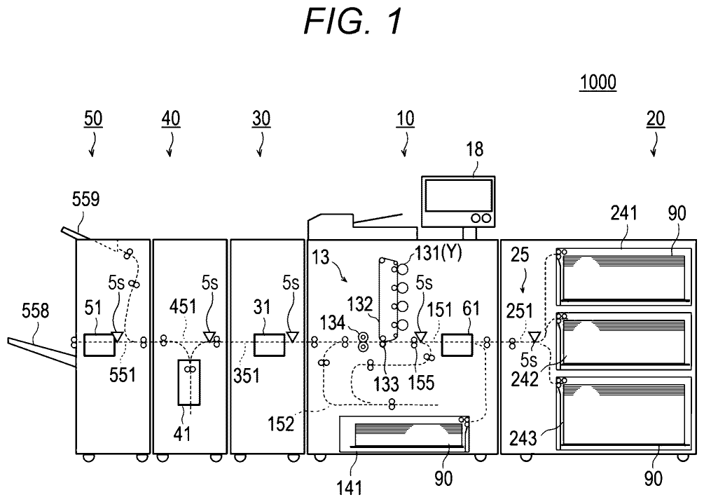

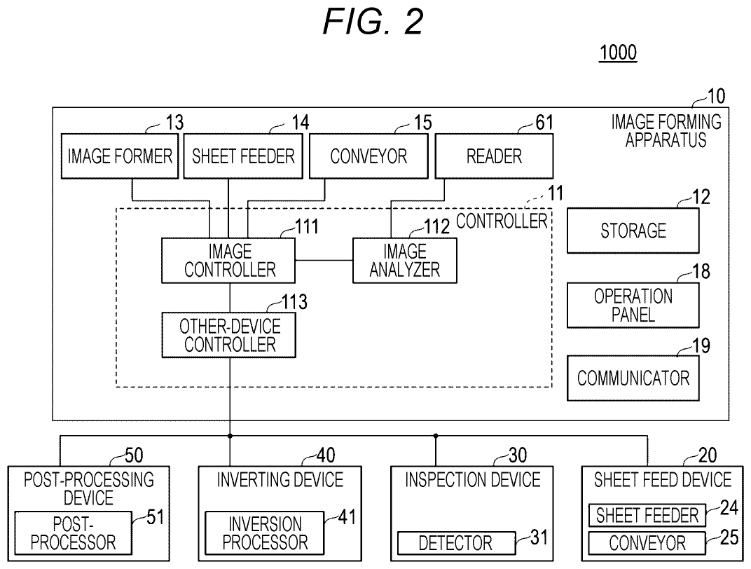

FIG. 1 is a diagram illustrating a schematic configuration of an image forming system 1000 according to the present embodiment. FIG. 2 is a block diagram illustrating a hardware configuration of the image forming system 1000. As illustrated in FIG. 1, the image forming system 1000 includes an image forming apparatus 10, a sheet feed device 20, an inspection device 30, an inverting device 40, and a post-processing device 50, which are mechanically and electrically connected to each other. The image forming system 1000 is not limited to the configuration illustrated in FIG. 1, and the sheet feed device 20, the inspection device 30, the inverting device 40, and the post-processing device 50 may not be provided. For example, the image forming system 1000 may be constituted by the image forming apparatus 10 alone. Furthermore, a plurality of post-processing devices 50 may be connected to the image forming system 1000.

### (Image Forming Apparatus 10)

The image forming apparatus 10 forms an image on a sheet 90 fed from the sheet feed device 20 on the upstream side. Furthermore, the image forming apparatus 10 forms an image on the sheet 90 fed from a sheet feeder 14 included in the image forming apparatus 10.

The image forming apparatus 10 includes a controller 11 (hardware processor), a storage 12, an image former 13, a sheet feeder 14, a conveyor 15, an operation panel 18, a communicator 19, a reader 61, and the like. These components are connected to each other via a signal line such as a bus for exchanging signals. Note that in FIG. 2, connection signal lines to some constituent elements such as the storage 12 and the operation panel 18 in the image forming apparatus 10 are not illustrated.

### (Controller 11)

The controller 11 includes a CPU, a ROM, a RAM, and the like. The controller 11 executes various kinds of processing by executing programs stored in the ROM and the storage 12 described later, and controls components of the apparatus and executes various kinds of calculation processing in accordance with the programs. The controller 11 also controls the entire image forming system 1000 in cooperation with controllers of other devices. The controller 11 functions as an image controller 111, an image analyzer 112, and an other-device controller 113. The functions of the sub-controllers 111 to 113 described above will be described later.

### (Storage 12)

The storage 12 includes an auxiliary storage such as a hard disk that stores various kinds of programs and various kinds of data. Further, the storage 12 stores sheet information regarding the sheets stored in each of sheet feed trays (sheet feed trays 141, 241 to 243, etc. to be described below) in association with the corresponding tray. The sheet information includes information regarding the brand, size (sheet width, sheet length), color, basis weight (weight), and type (gloss coated paper, matt coated paper, plain paper, high-quality paper, rough paper, etc.) of the sheet. In addition, the storage 12 may store a sheet brand, a determination model (determination model algorithm) used for determining a control parameter, and a paper profile.

The storage 12 may further store various additional images. The additional images include an image for image position adjustment, an image for gradation correction, an image for determination of cutting position, and a stamp image. The image for image position adjustment is a test image including a plurality of line images used for adjustment in the main scanning direction and in the sub-scanning direction, adjustment of the inclination, and adjustment of the magnification of each color of the image former 13. The image for gradation correction is a chart image including a plurality of gradation patches that vary in color and density. The image for determination of cutting position is a so-called registration mark having a cross shape. The image for determination of cutting position is used as a position detection mark to detect positional misalignment of the image on the sheet 90. The charts and patterns of the image for image position adjustment, the image for gradation correction, and the image for determination of cutting position are formed on the sheet 90, and are read by the inspection device 30 on the downstream side.

### (Image Former 13)

The image former 13 forms an image by, for example, an electrophotographic method. The image former 13 includes writing sections (laser exposure sections) and photosensitive drums respectively corresponding to basic colors of yellow (Y), magenta (M), cyan (C), and black (K), and developing devices each accommodating a two-component developer including toner of the corresponding color and a carrier. In FIG. 1, only the photosensitive drum 131(Y) for Y color is denoted by a reference numeral, and reference numerals for other constituent elements are omitted. Furthermore, the image former 13 further includes an intermediate transfer belt 132, a secondary transferer 133, and a fixer 134. The toner images formed on the photosensitive drums by the developing devices of the respective colors are superimposed on the intermediate transfer belt, and are transferred onto the conveyed sheet 90 in the secondary transferer 133. The toner image on the sheet 90 is heated and pressed by the fixer 134 on the downstream side, thereby being fixed onto the sheet 90.

### (Sheet Feeder 14, Conveyor 15)

The sheet feeder 14 includes a sheet feed tray 141. The conveyor 15 includes conveyance paths 151 and 152. The conveyance path 151 includes a registration roller 155, a plurality of conveyance roller pairs provided along the conveyance path, and a drive motor (not illustrated) that drives the conveyance roller pairs. The sheet feeder 14 includes a delivery roller that delivers an uppermost sheet of a plurality of sheets 90 loaded and placed in the sheet feed tray 141, and delivers the sheets 90 in the sheet feed tray to a conveyance path on the downstream side one by one. A conveyance path 251 is connected to the upstream side of the conveyance path 151, and the conveyance path 351 is connected to the downstream side of the conveyance path 151. The registration roller 155 adjusts a timing of the leading end of the sheet 90 to be conveyed (coarse adjustment) and corrects skew of the sheet 90. Specifically, the sheet 90 fed from the sheet feed tray 141 or the like to the conveyance path 151 is abutted against the temporarily stopped registration roller 155 and stopped. At this time, a loop (slack) of the sheet is formed between loop rollers (conveyance roller pair immediately upstream of the registration rollers) and the registration roller 155. Then, the leading end of the sheet 90 is moved along the axial direction of the registration roller 155, so that the skew of the sheet 90 is corrected. In addition, the sheet 90 that is stopped by being abutted against the registration roller 155 is re-conveyed in synchronization with the image formation timing, and the leading end timing is adjusted.

The conveyor 15 conveys the sheet 90 fed from the sheet feed tray 141 or the like. After an image is formed on the sheet 90 conveyed through the conveyance path 151 by the image former 13, the sheet 90 is ejected onto a sheet ejection tray 558 via the subsequent inspection device 30, the inverting device 40, the post-processing device 50, and the like. In double-sided printing in which an image is also formed on the back surface (second surface) of the sheet 90, the sheet 90 on which an image has been formed on one side is conveyed to the conveyance path 152 for double-sided image formation in a lower portion of the apparatus body. The sheet 90 conveyed to the conveyance path 152 is turned over by a switchback path and then conveyed to the conveyance path 151 for single-sided printing, and an image is again formed on the other side of the sheet 90 by the image former 13.

A plurality of sheet passing sensors 5s is disposed in the conveyance paths 151 and 152 of the conveyor 15. One of them can be disposed immediately upstream of the registration roller 155. The sheet passing sensors 5s detect a sheet being conveyed. The image controller 111 and the controller of the post-processing device determine the position of the end of the sheet 90 on the basis of the detection signal of the sheet passing sensors 5s, and execute a first process based on the end of the sheet 90.

### (Operation Panel 18, Etc.)

The operation panel 18 includes a touch screen, a numeric keypad, a start button, a stop button, and the like. The operation panel 18 displays a state of the image forming apparatus 10 or the image forming system 1000, and is used to input various settings and instructions from a user. A user can set, through a setting screen of the operation panel 18, information regarding the type and size of sheets loaded in the sheet feed trays 141, 241, and the like.

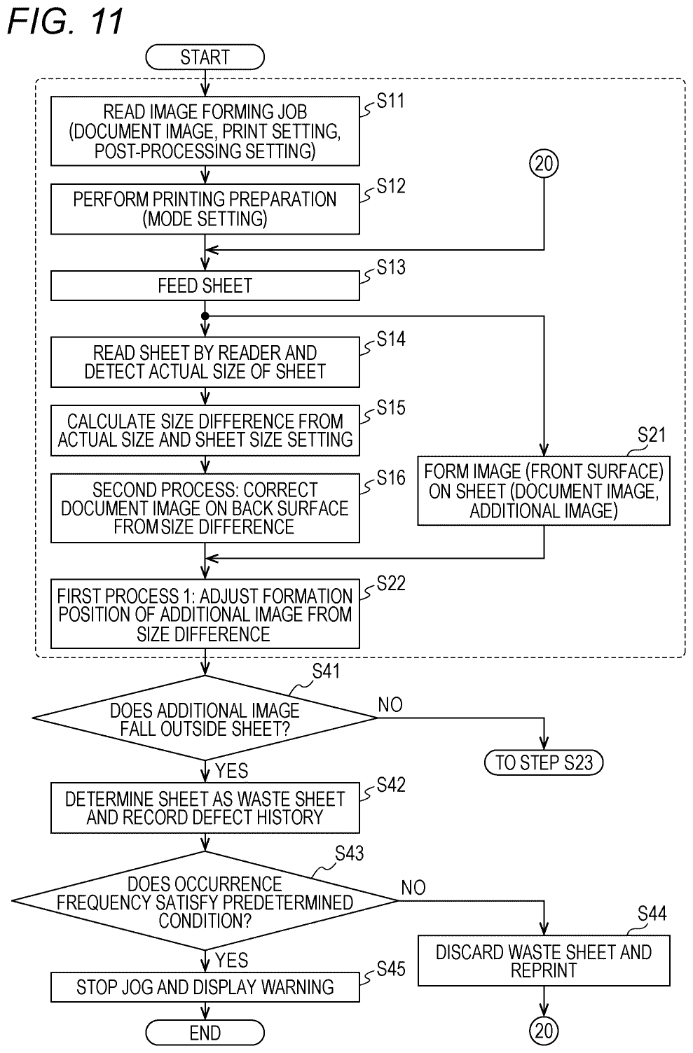

The communicator 19 is an interface for communicating with a personal computer (PC) or other devices 20, 30, 40, or the like. Furthermore, in a case where, for example, the reader 61 is not incorporated in the image forming apparatus 10 as in a second embodiment in FIG. 11 described later, the communicator 19 cooperates with the controller 11 to function as an acquirer that acquires information on the actual size of the sheet 90 from the reader 61.

### (Reader 61)

The reader 61 includes a reading sensor and a background section. The reading sensor is a one-dimensional line sensor including a plurality of photoelectric conversion elements arranged in a width direction orthogonal to the conveyance direction of the sheet 90, and reads a one-dimensional image. In the following, the conveyance direction is also referred to as a sub-scanning direction or a Y direction (coordinate Y). The width direction is also referred to as a main scanning direction or an X direction (coordinate X). The reading sensor includes an optical element such as a light emitting element and a lens array arranged along the line of the photoelectric conversion elements. During reading, the light emitting element emits light that is uniform in an extending direction of the line toward the sheet 90 on the conveyance path 151. The reader 61 reads the sheet 90, whereby read data corresponding to one sheet is generated. The image analyzer 112 recognizes the edges of the sheet 90 on the basis of the generated read data and detects the lengths of the four sides, the internal angles of four angles, the entire shape, and the size (hereinafter referred to as actual size) of the sheet 90.

### (Sub-Controllers 111 to 113)

When receiving a print job, the image controller 111 executes the print job on the basis of print job setting information of the input print job. The print job is input in response to an instruction sent from the operation panel 18 or an external terminal such as a network-connected PC operated by the user.

The image controller 111 controls feeding and conveyance of the sheet 90 by controlling the conveyor 15 (including the conveyance paths 151 and 152 and the drive motor for the fixer, and the like) and the sheet feeder 14. In addition, the image controller 111 instructs the reader 61 to read the sheet 90 on which an image has not yet been formed (reading instruction) according to the setting of the print job (also referred to as an image forming job). The image controller 111 also controls the image former 13. The image former 13 corrects an image to be formed on the sheet 90 on the basis of the image forming condition and a size difference which is the difference between the acquired sheet size setting or document image size and the actual sheet size detected by the image analyzer 112. The correction of the image by the image analyzer 112 (hereinafter, also referred to as second process or second processing) can include at least one of modification of the document image, control of the sheet conveyance timing, control of the image formation timing, and adjustment of the vertical and horizontal magnifications. Hereinafter, the above-mentioned correction of an image by the image analyzer 112 is also referred to as position correction control.

The image analyzer 112 controls the reader 61 in response to an execution instruction request (reading instruction) from the image controller 111. In response to the execution instruction request, the reader 61 causes the reading sensor and other various sensors to execute measurement of sheet characteristics. When the reader 61 reads the sheet 90, the image analyzer 112 acquires the read data generated by the reader 61.

The image analyzer 112 executes processing (hereinafter, also referred to as a first process or first processing) that is controlled based on the end of the sheet, separately from the second process related to the image correction for the image formation based on the print job described above. Similarly to the second process, the first process is executed based on the actual size. As will be described in detail later, the first process is performed by the image analyzer 112 and the image controller 111 in cooperation with each other. The first process controlled based on the end of the sheet includes at least one of the position correction of an additional image or the position correction for the post-processing.

The other-device controller 113 controls the sheet feed device 20, the inspection device 30, the inverting device 40, and the post-processing device 50. The other-device controller 113 communicates with the sheet feed device 20 to transmit and receive a sheet feed tray to be used, a sheet conveyance timing, and the like. The other-device controller 113 transmits, to the inspection device 30, whether or not the execution of inspection is issued and the position information regarding the document image position and the additional image position used as the reference of the inspection. The other-device controller 113 transmits, to the post-processing device 50, a sheet conveyance timing, information regarding setting of post-processing for a sheet to be conveyed, and the like. The other-device controller 113 transmits or receives a sheet conveyance timing for post processing, or the like to and from the post-processing device 50. In addition, the other-device controller 113 transmits, to the post-processing device 50, the setting information for the post-processing of the sheet to be conveyed, a correction value of the position correction control for the post-processing, or a correction value of the position correction control of the image by the image analyzer 112.

### (Sheet Feed Device 20)

As illustrated in FIGS. 1 and 2, the sheet feed device 20 includes the sheet feeder 24 and the conveyor 25. In addition, the sheet feed device 20 includes a controller, a storage, and a communicator (none of which are illustrated) in addition to the sheet feeder 24 and the conveyor 25, and these components are connected to each other via a signal line such as a bus for exchanging signals.

The sheet feeder 24 includes a plurality of sheet feed trays 241 to 243. The sheet feeder 24 and the conveyor 25 have the same functions as those of the sheet feeder 14 and the conveyor 15, feed the sheets 90 placed on the sheet feed trays 241 or the like one by one, and convey the sheets 90 to the conveyance path 251. The conveyance path 251 is connected to the subsequent conveyance path 151. The sheet 90 fed from each of the sheet feed trays 241 and the like and conveyed on the conveyance path 251 is conveyed to the reader 61 on the downstream side, and the sheet characteristics of the sheet 90 such as the sheet size are measured or an image is formed on the sheet 90 by the image former 13 on the further downstream side.

### (Inspection Device 30)

As illustrated in FIGS. 1 and 2, the inspection device 30 includes a detector 31. In addition, the inspection device 30 includes a controller, a storage, and a communicator (none of which are illustrated) in addition to the detector 31, and these components are connected to each other via a signal line such as a bus for exchanging signals. The detector 31 is disposed on the conveyance path 351, and reads the image on the conveyed sheet 90 on which the image has been formed by the image forming apparatus 10. Note that the same detectors 31 are disposed on and under the conveyance path 351 so that both surfaces can be read simultaneously (single pass). Each of the detectors 31 includes a sensor array, a lens optical system, an LED light source, and a housing that houses these components. The sensor array is a color line sensor including multiple optical elements which are CCDs or CMOSs and which are arranged linearly in a main scanning direction. A widthwise reading region of the sensor array corresponds to a full width of the sheet 90. The optical system includes a plurality of mirrors and lenses. Light from the LED light source is transmitted through a document glass and irradiates the front surface of the sheet 90 passing through the reading position on the conveyance path 351. The image by light reflected on the front surface at the reading position is guided by the optical system and is formed on the sensor array. The resolution of the detector 31 is, for example, 100 to several hundred dpi.

The inspection device 30 performs inspection by comparing the document image as a comparison image with image data (data to be inspected) obtained by reading performed by the detector 31. The difference between the document image and the data to be inspected is calculated for each pixel to detect stains. In a case where the pixel having a predetermined density or higher has a predetermined size or larger, the sheet is determined to be a stained defective product and is ejected to a sub sheet ejection tray 559 as waste sheet to be discarded.

### (Inverting Device 40)

As illustrated in FIGS. 1 and 2, the inverting device 40 includes an inversion processor 41. In addition, the inverting device 40 includes a controller, a storage, and a communicator (none of which are illustrated) in addition to the inversion processor 41, and these components are connected to each other via a signal line such as a bus for exchanging signals. The inverting device 40 includes a main conveyance path 451 and the inversion processor 41 that branches from the conveyance path 451 and inverts the sheet 90 conveyed from the image forming apparatus 10. The inverting device 40 causes the inversion processor 41 to convey the sheet 90, so that the sheet 90 is switched back and turned over, by which the front surface (first surface) of the sheet 90 faces upward.

### (Post-Processing Device 50)

The post-processing device 50 performs post-processing on the sheet 90 sent from the image forming apparatus 10 or ejects the sheet 90 according to the setting of the print job. The post-processing device 50 includes sheet ejection trays 558 and 559, a post-processor 51, a conveyance path 551, and the like. In addition, the post-processing device 50 includes a controller, a storage, a conveyor, and a communicator (none of which are illustrated), and these components are connected to each other via a signal line such as a bus for exchanging signals. The sheet ejection trays 558 and 559 are selected in accordance with the setting of the print job. For example, the sheet ejection tray 559 is used to eject a defective sheet (also referred to as a waste sheet). The conveyance path 551 is connected to the conveyance path 451 on the upstream side. The post-processor 51 performs at least one post-processing among cutting, stapling, punching, saddle stitching, perfect binding, case binding, and creasing on the sheet 90 on which the image is formed.

### (1. First Processing and Second Processing Based on Actual Sheet Size)

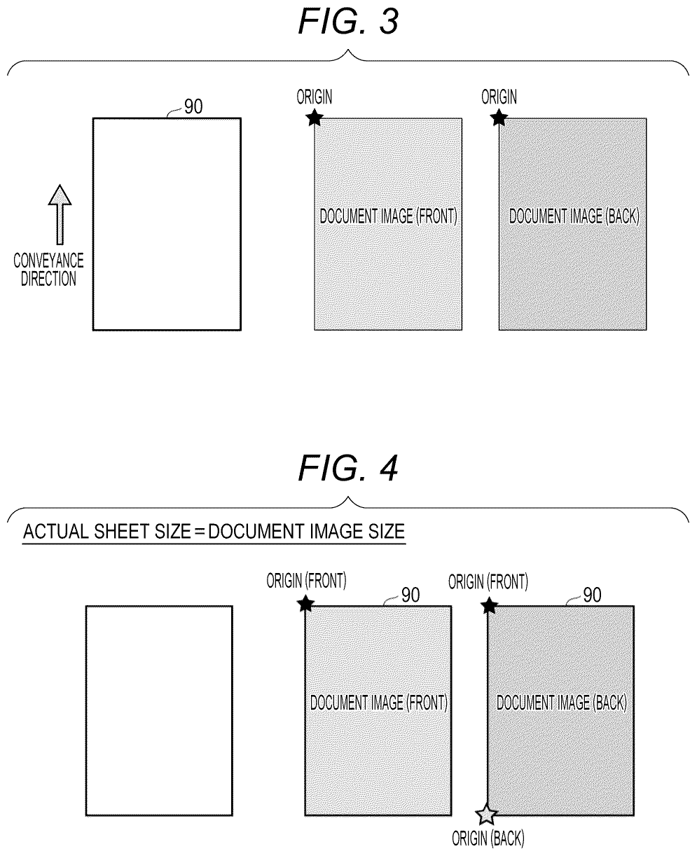

The first processing and the second processing based on the actual sheet size will be described below with reference to FIGS. 3 to 6D.

The second processing is control related to image formation based on a print job executed on the basis of the actual sheet size. The second processing is image correction for controlling image formation such that the image positions on the front and back surfaces of the sheet 90 overlap (are aligned with) each other on the basis of the actual sheet size. The first processing is different from the control related to image formation based on the print job and is control executed on the basis of the actual sheet size using the end of a sheet as a reference. The first processing includes at least one of correction processing related to processing for forming an additional image on a sheet by the image former 13 and correction processing related to post-processing to be performed by the post-processor 51 on the sheet on which an image has been formed. In the following, the former correction processing related to the processing for forming an additional image is particularly referred to as first processing 1, and the latter correction processing related to the post-processing is particularly referred to as first processing 2. First, the second processing will be described, and then the first processing will be described.

### (Second Processing)

In the following description, it is assumed that the following processing is performed as the second processing.

(s1) The image analyzer 112 detects (calculates) the actual size on the basis of the read data generated by the reading operation of reading the sheet 90 by the reader 61.

(s2) The image controller 111 causes the image former 13 to form an image on the front surface (first surface) of the sheet 90 on the basis of the setting of the print job. Here, s1 and s2 are processes performed in parallel.

(s3) The image analyzer 112 corrects the document image on the back surface by an amount of difference between the actual size and a value of the document image size. The correction of the image includes any of modification of the document image on the back surface, shift of the formation position of the document image on the back surface, change in the sheet conveyance timing, and control of the image formation timing. For example, the image analyzer 112 modifies the document image on the back surface as the correction of the document image on the back surface.

(s4) The image controller 111 causes the image former 13 to form an image on the back surface (second surface) of the sheet 90 using the document image on the back surface modified by the image analyzer 112. Thus, the image that has been formed on the front surface and the image on the back surface are aligned between the front surface and the back surface. The term “aligned” as used herein means that the origins of the image formation regions are aligned between the front surface and the back surface. Note that, although the value of the document image size is used here, the same processing can be performed using a sheet size setting value.

FIG. 3 is a schematic diagram illustrating an actual sheet size and a document image size. The document image is printed on the sheet 90 with the upper left as the origin.

### 2. Actual Sheet Size=Document Image Size

FIG. 4 is a schematic diagram for describing correction of an image when the actual sheet size and the document image size are the same. The document image is printed on the sheet 90 with the upper left as the origin. In this case, the image analyzer 112 does not substantially modify the document image on the back surface (modification amount is zero) in the second processing. The image controller 111 forms the document image (back surface) of the print job without any change on the sheet 90. Similarly, the image analyzer 112 does not substantially perform correction (correction amount=zero) in the first processing.

### 3. Actual Sheet Size>Document Image Size

### 3.1 Second Processing

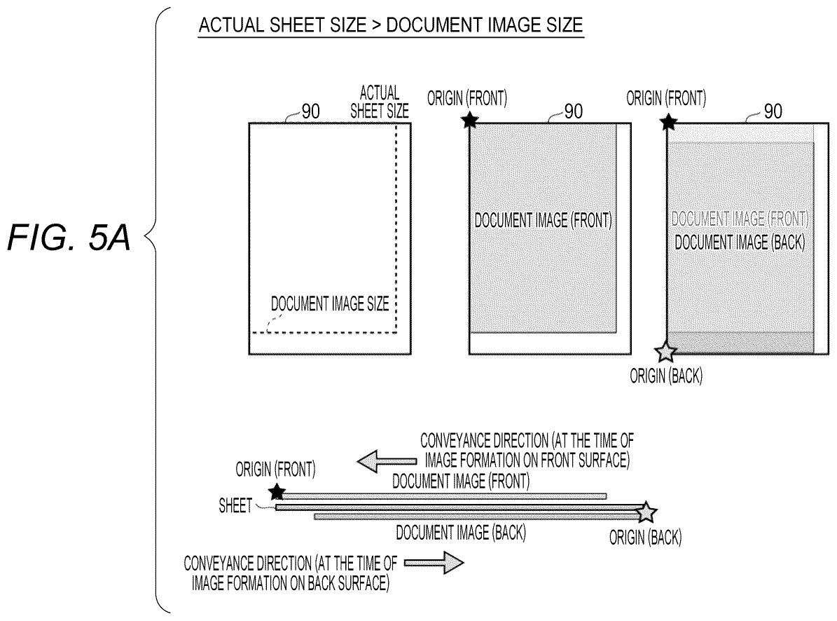

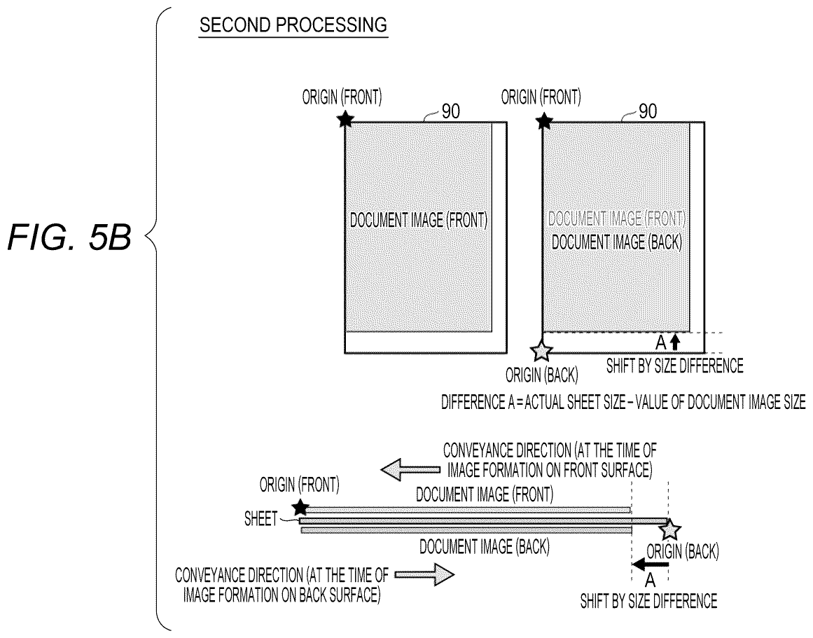

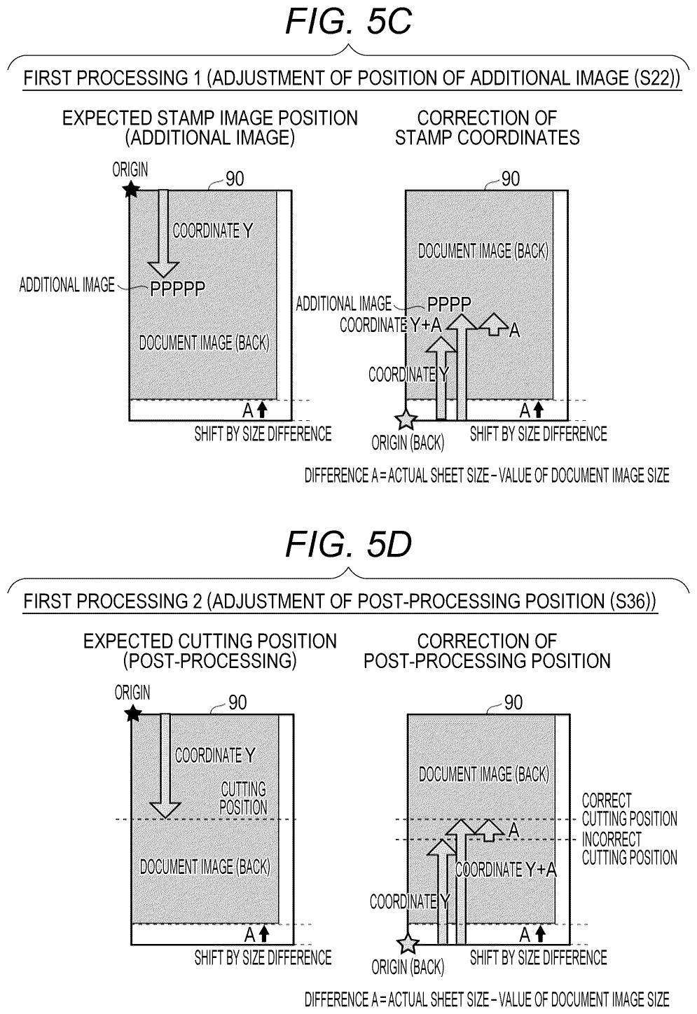

FIGS. 5A and 5B are schematic diagrams illustrating image correction in a case where the actual sheet size is larger than the document image size. FIG. 5A is a diagram illustrating an image formation state in a case where image correction is not performed. When the image correction is not performed, the document images on the front and back surfaces are formed (arranged) with the leading end as a reference, and thus the images on the front and back surfaces do not overlap.

FIG. 5B is a diagram illustrating an image formation state in a case where image correction is performed. The image analyzer 112 changes the document image on the back surface on the basis of the actual size. In this case, the image analyzer 112 translates (shifts the position of) the image by a difference A (=actual sheet size-value of document image size) in a direction in which the image is delayed at the time of image formation on the back surface. The image controller 111 allows image formation on the sheet 90 using the document image on the back surface modified by the image analyzer 112.

### 3.2 First Processing

FIGS. 5C and 5D are schematic diagrams illustrating the first processing in a case where the actual sheet size is larger than the document image size. In the first processing, the image analyzer 112 executes correction processing related to the additional image and/or the post-processing by using the same size difference as that used in the second processing.

### 3.2.1 First Processing 1 (Additional Image)

The image analyzer 112 corrects the formation position of the additional image. As described above, the additional images include an image for image position adjustment, an image for gradation correction, an image for determination of cutting position, and a stamp image. A case where a stamp image is set as the additional image will be described below, but the same processing can be applied to other additional images including the image for image position adjustment, the image for gradation correction, and the image for determination of cutting position. The additional image is printed based on the leading end of the sheet 90 by specifying a print coordinate in the hardware (ASIC) of the image controller 111 based on the leading end of the sheet 90. The image analyzer 112 specifies, in the hardware (ASIC) of the image controller 111, the print coordinate after the position correction in which the print coordinate of the additional image is shifted by the same amount as the shift amount specified in the second process of step S16.

As illustrated in FIG. 5C, the expected stamp position based on the print setting is set to coordinate Y. The image analyzer 112 shifts the print coordinate by the size difference A with respect to the coordinate Y. The print coordinate of the stamp image after the position correction is Y+A.

### (3.2.2 First Processing 2 (Post-Processing))

The image analyzer 112 makes a setting for correction of the processing position for the post-processing. The post-processing device 50 receives, from the image forming apparatus 10, correction setting of the processing position for the post-processing set by the image analyzer 112, and executes the post-processing on the basis of the correction setting.

As described above, the post-processing includes any of cutting, stapling, punching, saddle stitching, perfect binding, case binding, and creasing. In the following, a case where cutting is set as post-processing will be described, but the similar processing can be applied to stapling, punching, saddle stitching, perfect binding, case binding, and creasing.

As illustrated in FIG. 5D, the expected cutting position based on the post-processing setting is set to coordinate Y. The image analyzer 112 shifts the cutting position in the cutting by the size difference A with respect to the coordinate Y. The coordinate of the cutting position after the position correction is Y+A.

### 4. Actual Sheet Size<Document Image Size

### 4.1 Second Processing

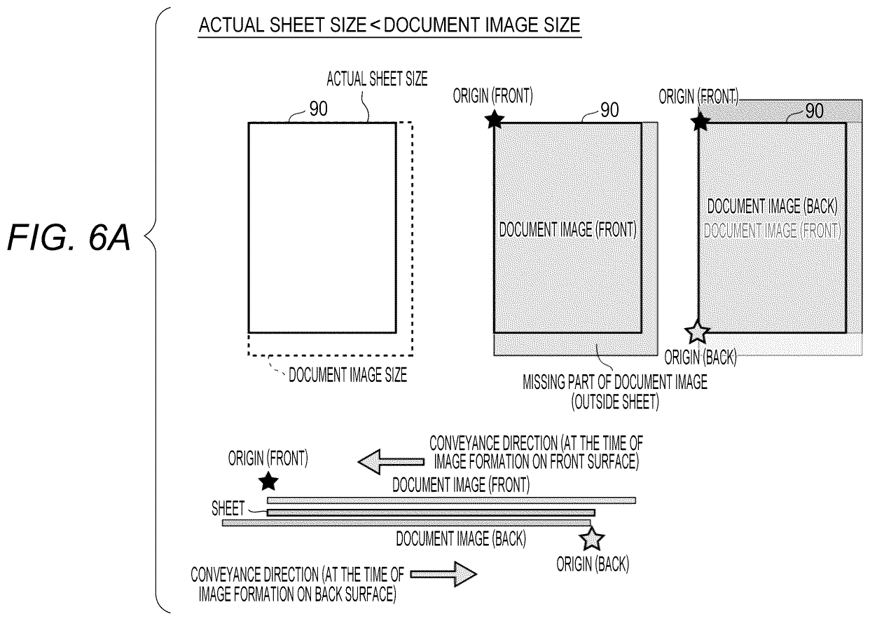

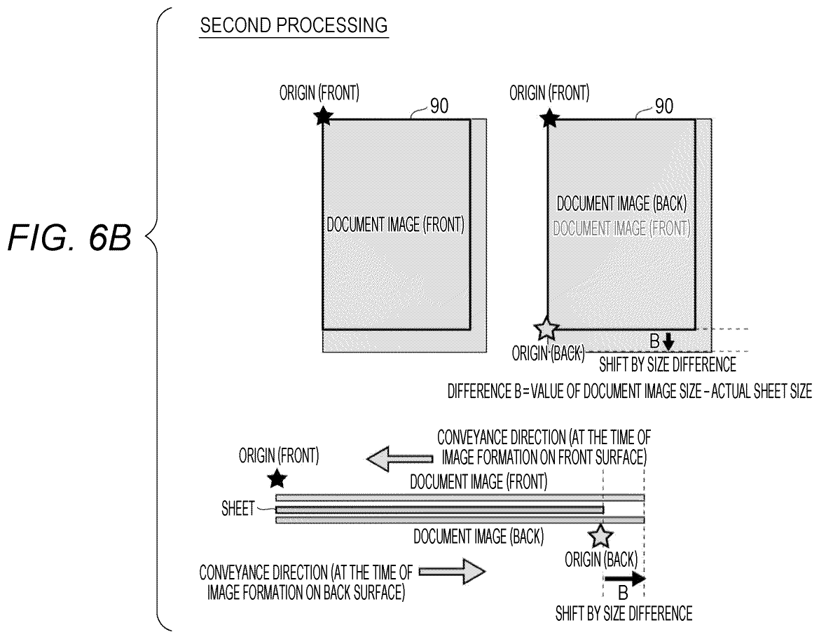

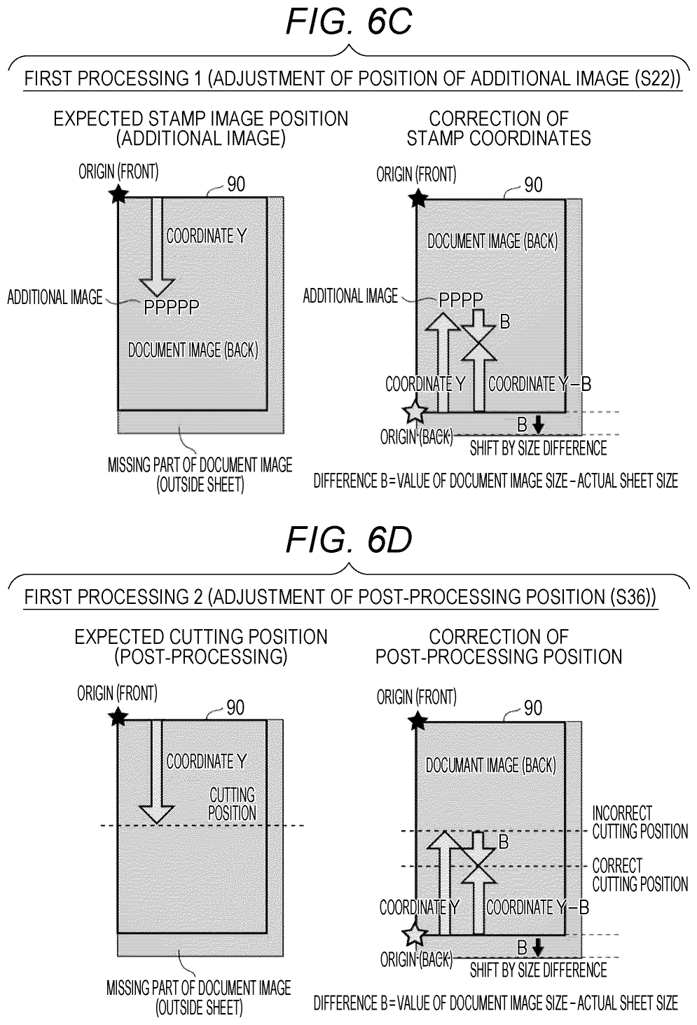

FIGS. 6A and 6B are schematic diagrams illustrating image correction in a case where the actual sheet size is smaller than the document image size. FIG. 6A is a diagram illustrating an image formation state in a case where image correction is not performed. The document images on the front and back surfaces are formed (arranged) with the leading end as a reference, and thus the images on the front and back surfaces do not overlap.

FIG. 6B is a diagram illustrating an image formation state in a case where image correction is performed. The image analyzer 112 changes the document image on the back surface on the basis of the actual size. In this case, as the modification of the document image on the back surface, the image analyzer 112 trims an area falling outside the actual sheet size to delete a part of the document image. The image analyzer 112 deletes a part of the document image on the back surface in the sub-scanning direction by a difference B (=value of document image size-actual sheet size) in the sub-scanning direction. In addition, also in the main scanning direction, a part of the document image on the back surface in the main scanning direction is deleted by a difference x (=value of document image size−actual sheet size). The image controller 111 allows image formation on the sheet 90 using the document image on the back surface modified by the image analyzer 112. In this case, the image controller 111 translates the image by the difference B (=value of document image size-actual sheet size) in a direction in which the image is delayed at the time of image formation on the back surface based on the document image on the back surface modified by the image analyzer 112. Note that although FIGS. 5B and 6B illustrate image correction in the sub-scanning direction (conveyance direction), misalignment between the front surface and the back surface in the main scanning direction does not occur because the origin does not change between the front and back surfaces in the main scanning direction.

### 4.2 First Processing

FIGS. 6C and 6D are schematic diagrams illustrating the first processing in a case where the actual sheet size is smaller than the document image size. In the first processing, the image analyzer 112 executes correction processing related to the additional image and/or the post-processing by using the same size difference as that used in the second processing.

### (4.2.1 First Process 1 (Additional Image))

As illustrated in FIG. 6C, the expected stamp position based on the print setting is set to coordinate Y. The image analyzer 112 shifts the print coordinate by the size difference B with respect to the coordinate Y. The print coordinate of the stamp image after the position correction is Y-B.

### (4.2.2 First Process 2 (Post-Processing))

As illustrated in FIG. 6D, the expected cutting position based on the post-processing is set to coordinate Y. The image analyzer 112 shifts the cutting position in the cutting by the size difference B with respect to the coordinate Y. The coordinate of the cutting position after the position correction is Y-B.

### 5. Modification Example

In the above description, the example in which the image data is shifted or trimmed in the second processing has been described, but the present invention is not limited thereto. By trimming, it is possible to prevent untransferred toner from adhering to the secondary transferer 133, so that it is possible to reduce a load in cleaning the secondary transferer 133. However, as another example, the sheet conveyance timing may be changed or the image formation timing may be controlled, provided that the cleaning performance is sufficient enough to withstand the load.

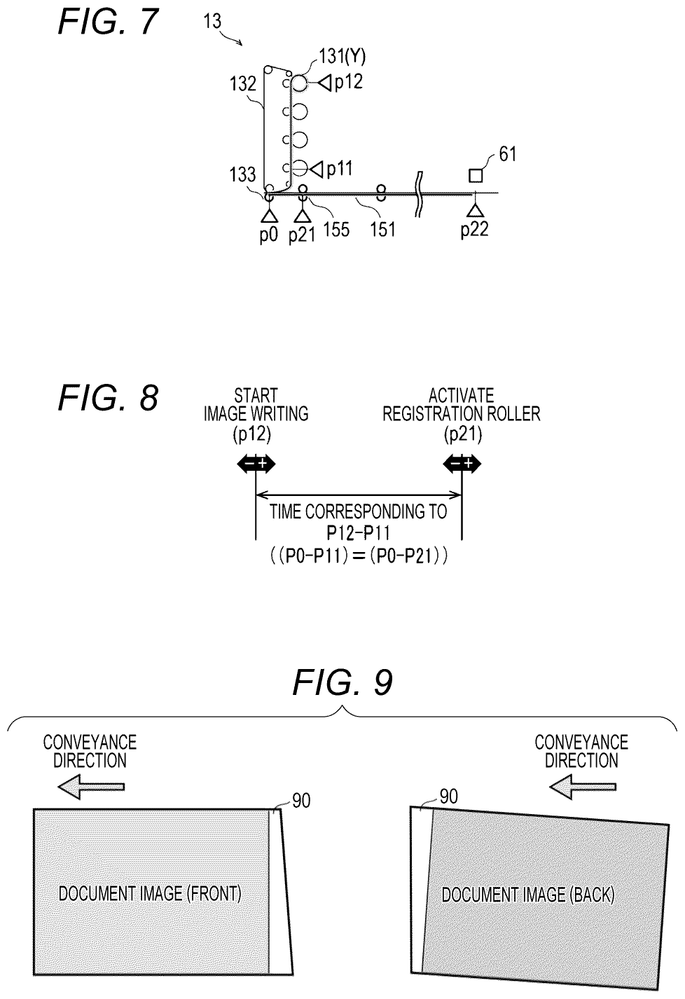

FIG. 7 is a schematic diagram illustrating a configuration of the conveyance path 151 around the image former 13. A position p12 is a writing position on the photosensitive drum 131(Y) on the most upstream of the image former 13. A position p0 is a secondary transfer position. A position p21 is a position of the registration roller 155. A position p22 is a reading position by the reader 61. The position p11 is a position corresponding to the position p21. The distance from the secondary transfer position p0 to the position p11 is the same as the distance from the secondary transfer position p0 to the position p21 of the registration roller. The distance herein refers to a moving distance of the toner image on the surface or a moving distance of the sheet 90. The distance from the writing position p12 to the secondary transfer position p0 is a distance through the surfaces of the photosensitive drum 131(Y) and the transfer belt 132 indicated in a thick line. When the correction is not performed, the registration roller 155 is activated at the timing at which the toner image at the leading end of the page reaches the position p11 to start conveyance of the sheet 90. The image controller 111 changes the activation timing of the registration roller 155 in order to advance or delay the image on the sheet. Alternatively, the image writing start timing is changed. In the examples of FIGS. 5B and 6B, the image controller 111 advances the activation timing of the registration roller 155 by a time corresponding to the difference A (difference A/conveyance speed), or delays the activation timing of the registration roller 155 by a time corresponding to the difference B. Alternatively, the image controller 111 delays the image writing start timing by a time corresponding to the difference A or advances the same by a time corresponding to the difference B.

Furthermore, in the above description, regarding a change in the sheet shape, a case where the sheet is larger or smaller with the rectangular shape (having four right-angled corners) being maintained is assumed, but it is not limited thereto, and in practice, the sheet shape may be a trapezoid or a parallelogram. In this case, since the sheet 90 is inclined with respect to the conveyance direction by a skew correction function of the registration roller 155, it is necessary to shift the image position also in the main scanning direction according to the inclination, that is, to print the image obliquely. FIG. 9 is a diagram illustrating a state in which the document image on the back surface is modified and printed as the second process. For the sheet 90 having such an actual size, the image analyzer 112 obliquely displaces the formation position of the additional image or obliquely displaces the processing position for the post-processing in accordance with the same modification amount of the document image on the back surface (correction amount of the document image on the back surface) also in the first process.

### (Printing Processing in First Embodiment)

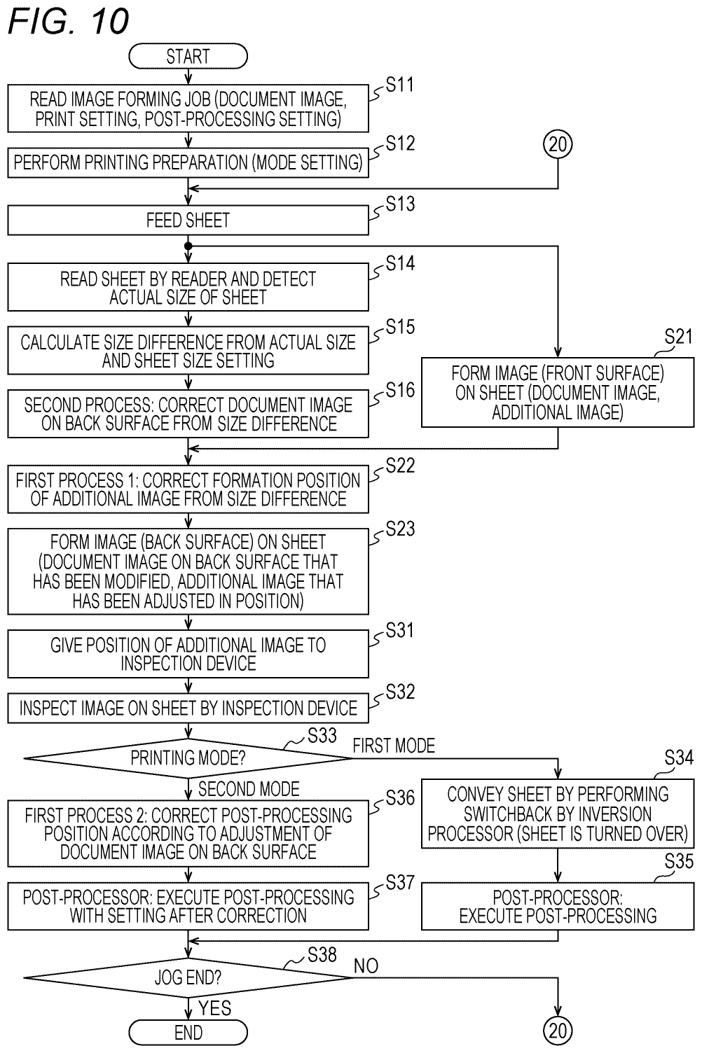

Next, printing processing executed by the image forming system 1000 according to the first embodiment will be described with reference to FIG. 10. The image forming system 1000 described below separately performs the first process controlled based on the end of the sheet, in addition to the second process related to the image correction for the image formation based on the print job.

### (Step S11)

The image controller 111 of the controller 11 reads a print job. The print job includes print data (document image data), print setting, and post-processing setting.

### (Step S12)

The controller 11 performs printing preparation. The printing preparation includes setting of a first mode and a second mode. Although details will be described later, the first mode is a mode in which the sheet 90 is conveyed with the front surface facing upward using the inverting device 40, and the second mode is a mode in which the position for the post-processing is corrected with the front surface facing downward. The controller 11 switches between the first mode and the second mode according to (1a) type of the post-processing, (1b) system configuration of the apparatus, and (1c) setting of the sheet ejection tray. For example, in a case where the sheet ejection tray to be used according to the setting is on a path (not illustrated) branching on the upstream side of the inverting device 40 so that the sheet cannot pass through the inverting device 40, the second mode is forcibly set. On the other hand, the first mode can be selected in a case where the sheet ejection tray is located so that the sheet can pass through the inverting device 40. In the first mode, the inversion processor 41 of the inverting device 40 is enabled.

(1a) Types of post-processing referred to by the controller 11 include post-processing performed on a sheet-by-sheet basis and post-processing performed on a sheet bundle including a plurality of sheets as a bundle, and the first mode is selected for the latter post-processing performed on the sheet bundle. The post-processing performed on a sheet-by-sheet basis includes, for example, cutting and creasing. The post-processing to be performed on the sheet bundle includes saddle stitching and case binding.

(1b) Examples of a system configuration of the apparatus referred to by the controller 11 include the presence or absence of the inverting device. When the inverting device is not connected to the image forming system 1000, the second mode is selected.

(1c) The controller 11 refers to the setting of the sheet ejection tray. In accordance with the setting of the sheet ejection tray, the first mode is selected in a case where face-up sheet ejection is set as the setting of the sheet ejection face, and the second mode is selected in a case where face-down sheet ejection is set.

### (Step S13)

The image controller 111 transmits, to the sheet feeder 24 of the sheet feed device 20 via the other-device controller 113, an instruction to start feeding the next sheet 90 from the sheet feed tray 241 designated in accordance with the print setting. The sheet feeder 24 feeds the sheet 90 from the designated sheet feed tray 241 or the like and conveys the sheet 90 through the conveyance path 251.

### (Step S14)

The reader 61 reads the conveyed sheet 90 and generates read data. The image analyzer 112 detects the actual size of the sheet from the read data.

### (Step S15)

The image analyzer 112 calculates a size difference from the actual size and the sheet size setting set in the print setting.

### (Step S16)

The image analyzer 112 corrects the document image on the back surface from the size difference calculated in step S15 as the second process. The correction setting set here is used for the image formation on the back surface. The second process here is as described with reference to FIGS. 5B, 6B, and the like.

### (Step S21)

In parallel with the reading of the sheet 90 and the setting processing for setting the correction amount in steps S14 to S16, an image is formed on the front surface of the sheet 90 by the image former 13 in step S21. When the image is formed on the front surface, the second process is not performed, and the document image is formed in accordance with the print setting. If the additional image is set, the additional image is formed on the sheet 90 without performing the position correction.

### (Step S22)

The image analyzer 112 corrects the formation position of the additional image from the size difference calculated in step S15 as the first process (first process 1). The first process 1 here is as described with reference to FIGS. 5C, 6C, and the like.

### (Step S23)

The image controller 111 controls the image former 13 to form an image on the back surface in a manner reflecting the second process and the first process 1. To be more specific, the image controller 111 forms the image on the back surface on the sheet 90 based on the document image on the back surface modified in step S16, and forms the additional image on the back surface of the sheet 90 by the position correction amount set in step S21.

### (Step S31)

Furthermore, the controller 11 of the image forming apparatus 10 gives the image data of the additional image and the corrected position information thereof to the inspection device 30.

### (Step S32)

The inspection device 30 reads, with the detector 31, both surfaces of the sheet 90 on which images are formed by the image forming apparatus 10. Then, the obtained read image data is compared with the document image to detect stain on the sheet 90. In addition, in order to prevent the additional image from being erroneously detected as stains, the additional image that has been corrected in position by the first process 1 is excluded from an object to be inspected. In a case where the stain having density equal to or higher than a predetermined value has a size equal to or larger than a predetermined size, the sheet is determined as a defective product and ejected onto the sheet ejection tray 559 as a waste sheet to be discarded.

### (Step S33)

When the mode set in step S12 is the first mode, the controller 11 advances the processing to step S34, and when the mode is the second mode, the controller advances the processing to step S36.

### (Step S34)

The inverting device 40 causes the inversion processor 41 to switch back the sheet and convey the sheet, so that the sheet is turned over.

### (Step S35)

The post-processor 51 performs post-processing on the sheet 90 on the basis of the post-processing setting. In this case, the correction processing of the first process 2 is not executed (unnecessary).

### (Step S36)

The image analyzer 112 corrects the processing position for the post-processing from the size difference calculated in step S15 as the first process (first process 2). Information on the corrected processing position is sent from the image forming apparatus 10 to the post-processing device 50. The first process 2 here is as described with reference to FIGS. 5D, 6D, and the like. Note that, as another example, the processing of calculating the correction amount in the first process 2 may be performed by the controller of the post-processing device 50 instead of the image analyzer 112. In this case, the controller 11 of the image forming apparatus 10 gives the size difference to the post-processing device 50. The controller of the post-processing device 50 calculates a correction amount for post-processing from the given size difference.

### (Step S37)

The post-processor 51 performs the post-processing at the corrected processing position set in step S37. That is, the post-processing in which the first process 2 is reflected is executed.

### (Step S38)

The controller 11 checks the print setting, and ends the processing when printing of all pages of the print job being executed ends (END). If the print job is not completed, the processing returns to step S13, and the processes in step S13 and subsequent steps are repeated.

As described above, the image forming system according to the present embodiment includes a sheet feeder that feeds a sheet, a conveyor that conveys the sheet through a conveyance path, an acquirer that acquires information on the actual size of the sheet, an image former that forms an image on the sheet conveyed through the conveyance path, and a controller. The controller controls a first process on the basis of the actual size acquired by the acquirer, the first process being controlled based on the end of the sheet separately from the image formation based on a print job. With such a configuration, it is possible to control the first process that is controlled based on the end of the sheet separately from the image formation based on a print job, even if the actual size changes.

In addition, the first processing to be controlled is processing of forming an additional image by the image former, and in this case, it is possible to appropriately correct the formation position of the additional image according to the actual size of the sheet. In addition, the first processing to be controlled is post-processing performed by the post-processor on a sheet on which an image has been formed, and in this case, it is possible to appropriately correct the processing position for the post-processing according to the actual size of the sheet.

### Second Embodiment

Next, printing processing according to the second embodiment will be described with reference to FIG. 11. In the second embodiment, when an additional image falls outside the sheet in a case where the processing of correcting the additional image is applied as the first process 1, the sheet is determined as a waste sheet.

### (Steps S11 to S22)

The processes from steps S11 to S22 (processes enclosed by a dotted line frame in FIG. 11) are the same as those in the first embodiment illustrated in FIG. 10, and thus, the description thereof will not be repeated.

### (Step S41)

When the position of the additional image is corrected by the correction in step S22, the controller 11 determines whether or not the additional image falls outside the sheet. When a part of the additional image falls outside the sheet, the controller 11 determines that the additional image falls outside the sheet. When determining that the additional image does not fall outside the sheet (NO), the controller 11 executes the processes in step S23 and subsequent steps illustrated in FIG. 10. On the other hand, when determining that the corrected additional image falls outside the sheet (YES), the controller 11 advances the processing to step S42.

### (Step S42)

The controller 11 determines the sheet 90 having the additional image falling outside the sheet as a waste sheet. In addition, the controller 11 records an event in which a waste sheet is generated in the storage 12 or the like as a defect history. In the defect history, a continuous occurrence count c1, a job occurrence count c2 which is the total number of times of occurrence in one print job, and a tray occurrence count c3 which is the number of times of occurrence in one sheet feed tray are counted. The tray occurrence count c3 is reset when the sheets 90 are newly loaded on the sheet feed tray or when the sheet feed tray is opened and closed.

### (Step S43)

The controller 11 determines whether or not the occurrence frequency satisfies a predetermined condition. In a case where any one of c1 (continuous occurrence count)≥N, c2 (job occurrence count in one print job)>M, and c3 (tray occurrence count in one sheet feed tray)>L is satisfied (YES), the controller 11 advances the processing to step S45. When none of the conditions are satisfied (NO), the controller 11 advances the processing to step S44.

### (Step S44)

The controller 11 discards the waste sheet and executes re-printing. Specifically, the controller 11 ejects the sheet 90 determined as a waste sheet on the sub sheet ejection tray 559. Furthermore, the controller 11 newly feeds the sheet 90 from the same sheet feed tray and performs printing again using the same print setting as the waste sheet, that is, using the document image used for the image formation for the waste sheet.

### (Step S45)

The controller 11 stops the print job being executed. The controller 11 also displays a warning by displaying a warning message on the operation panel 18 or the like.

### Modification Example

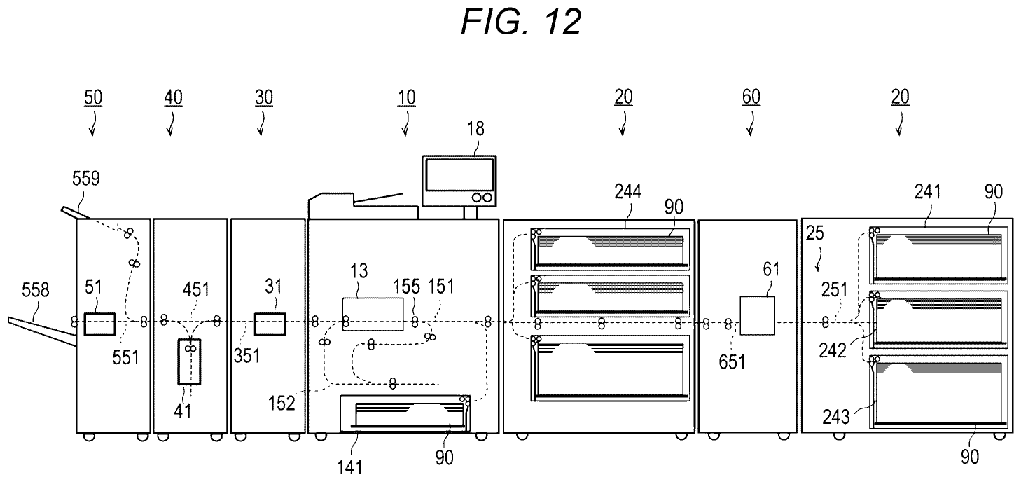

FIG. 12 is a diagram illustrating a schematic configuration of an image forming system according to a modification example. Although the first embodiment illustrated in FIG. 1 and the like has described an example in which the reader 61 is incorporated in the image forming apparatus 10, a reading device 60 that detects an actual size may be incorporated in an image forming system 1000 as illustrated in FIG. 12. The reading device 60 includes a reader 61 disposed on an internal conveyance path 651, reads the sheet 90 conveyed from the sheet feed device 20 on the upstream side, and detects the actual size of the sheet. The acquirer (the communicator 19 and the controller 11) of the image forming apparatus 10 acquires information on the actual size from the reading device 60 and controls the first processing and the second processing on the basis of the acquired information on the actual size.

In addition, in the modification example illustrated in FIG. 12, the distance between the positions p0 and p22 (refer to FIG. 7) is sufficiently long, and thus, it is possible to reflect the first processing and the second processing based on the actual size read by the reader 61 in the image formation on the front surface (first surface). Specifically, in the modification example illustrated in FIG. 12, the distance between the positions p0 and p22 is sufficiently long, and thus, the reader 61 is disposed in a positional relationship such that the following (b) comes later than the following (a). Therefore, the image controller 111 can perform the first processing and the second processing on the first surface of the sheet 90 that has been read.

(a) Timing at which preparation for image formation reflecting the position correction control of the first processing 1 and the second processing is completed from the image data obtained by the reader 61 reading the sheet 90.

(b) Start timing of image formation on the sheet 90.

### Another Modification Example

The main configurations of the reader 61 and the image forming system 1000 including the reader 61 have been described for describing the features of the above embodiments, and the configurations of the reader 61 and the image forming system 1000 including the reader 61 described above are not limited to the above-mentioned configurations, and can be modified in various manners within the scope of the claims. In addition, a configuration included in a general image forming apparatus is not excluded.

For example, in the example illustrated in FIG. 10 and the like, the first processing 1 is executed on the additional image, but in a case where the additional image is of a type that is combined with the entire surface of the sheet, the shift of the print coordinates of the additional image based on the correction amount of the document image on the back surface may not be executed. Examples of such cases include a case where the additional image is a stamp image to be combined not at a specific position on the sheet but on the entire surface of the sheet, such as a copy protection indication or watermark numbering. In the case of such a stamp image to be combined with the entire surface of the sheet, the relative positional relationship between the stamp image and characters or images of the document image is meaningless, and thus, only the second processing is performed, and the first processing 1 regarding the position control for the additional image can be eliminated.

In addition, the means and method for performing various kinds of processing in the reader 61 and the image forming system 1000 according to the above-described embodiments can be implemented by either a dedicated hardware circuit or a programmed computer. The program may be provided by, for example, a computer-readable recording medium such as a USB memory or a digital versatile disc (DVD)-ROM, or may be provided online via a network such as the Internet. In this case, the program recorded on the computer-readable recording medium is commonly transferred to and stored in a storage such as a hard disk. In addition, the program may be provided as independent application software or may be incorporated into software of an apparatus as one function of the apparatus.

While the embodiments of the present invention have been described and illustrated in detail, the disclosed embodiments have been created for purposes of illustration and example only, and not limitation. The scope of the present invention is to be interpreted by the wording of the appended claims.

What is claimed is:

1. An image forming system comprising:
a sheet feeder that feeds a sheet;
a conveyor that conveys the sheet through a conveyance path;
an acquirer that acquires information on an actual size of the sheet;
an image former that forms an image on the sheet conveyed through the conveyance path; and
a hardware processor that controls at least one of the sheet feeder, the conveyor, the acquirer, and the image former, wherein
the hardware processor controls a first process on the basis of the actual size acquired by the acquirer, the first process being controlled based on an end of the sheet separately from image formation based on a print job.

2. The image forming system according to claim 1, wherein the first process controlled based on the end of the sheet is processing of forming an additional image on the sheet by the image former.

3. The image forming system according to claim 1, wherein the first process controlled based on the end of the sheet is post-processing executed by a post-processor on the sheet on which an image has been formed.

4. The image forming system according to claim 1, wherein
the acquirer includes a reader that is provided between the sheet feeder and the image former in the conveyance path and reads the sheet conveyed through the conveyance path, and
the hardware processor controls, on the basis of an actual size calculated on the basis of a reading result by the reader, a position of the additional image to be formed on the sheet by the image former as the first process, separately from the image formation based on the print job.

5. The image forming system according to claim 4, wherein the additional image includes at least one of an image for image position adjustment, an image for gradation correction, an image for determination of cutting position, and a stamp image.

6. The image forming system according to claim 1, wherein
the hardware processor acquires a sheet size of the sheet set in a sheet feed tray of the sheet feeder or a size of a document image set in the print job,
calculates a size difference which is a difference between the actual size acquired by the acquirer and the sheet size or the size of the document image, and
executes a second process of controlling image formation on the basis of the size difference so that image positions on a front surface and a back surface of the sheet are aligned with each other when image formation based on the print job is performed.

7. The image forming system according to claim 6, wherein the second process for controlling image formation includes at least one of modification of a document image in a print job, adjustment of a sheet conveyance timing, and adjustment of an image formation timing.

8. The image forming system according to claim 6, wherein
the acquirer includes a reader that is provided between the sheet feeder and the image former in the conveyance path and that reads an actual size of the sheet conveyed along the conveyance path,
image forming process on the front surface of the conveyed sheet by the image former and reading process of the sheet by the reader are performed in parallel with each other,
the acquirer acquires a sheet size of the sheet set in a sheet feed tray of the sheet feeder or a size of a document image set in a print job, and
on the basis of a size difference that is a difference between the actual size of the sheet acquired by reading and the sheet size or the size of the document image, the hardware processor corrects, as the second process, the document image on the back surface in the print job such that an image position on the back surface of the sheet during image formation based on the print job is aligned with an image on the front surface on which the image has already been formed, and
performs control so that variations for each sheet is reduced on the basis of the size difference as the first process.

9. The image forming system according to claim 3, wherein the post-processing includes at least one of cutting, stapling, punching, saddle stitching, perfect binding, case binding, and creasing.

10. The image forming system according to claim 8, wherein
the hardware processor controls, on the basis of the actual size calculated on the basis of a reading result by the reader, a position of the additional image to be formed on the sheet by the image former as the first process, separately from the image formation based on the print job, and
shifts a print coordinate of the additional image according to a correction amount of the document image on the back surface as the control of the position on the sheet.

11. The image forming system according to claim 8, wherein
the first process controlled based on the end of the sheet is post-processing to be performed by a post-processor on the sheet on which the image has been formed,
an inversion processor that turns over the sheet on which the image has been formed is provided upstream of the post-processor,
a first mode and a second mode are executable,
the first mode being a mode for conveying all of the sheets subjected to image formation to the post-processor in a face-up manner,
the second mode being a mode for shifting a position for the post-processing at the post-processor according to a correction amount of the document image on the back surface, and
the hardware processor switches between the first mode and the second mode according to a type of the post-processing, a system configuration of the apparatus, and setting of a sheet ejection tray.

12. The image forming system according to claim 11, wherein the first mode is applied when the post-processing is of a type that is to be executed on a plurality of sheets.

13. The image forming system according to claim 11, wherein the first mode or the second mode is applied when the post-processing is of a type executed on each of the sheets, and
the second mode is applied when the first mode is inapplicable due to an apparatus configuration or the setting of the sheet ejection tray.

14. The image forming system according to claim 10, wherein, when a part or entire of the additional image that has been shifted falls outside the sheet, the hardware processor determines the sheet to be discarded.

15. The image forming system according to claim 10, wherein, when a part or entire of the additional image that has been shifted falls outside the sheet, the hardware processor determines the sheet to be discarded, and performs printing again with a print setting same as a print setting for the sheet determined to be discarded.

16. The image forming system according to claim 10, wherein, when at least one of the following conditions is satisfied: an event in which a part or entire of the additional image that has been shifted falls outside the sheet occurs N times or more in a row; the event occurs M times or more in one print job; and the event occurs L times or more in one sheet feed tray of the sheet feeder, the hardware processor stops the print job in execution and provides a warning display.

17. The image forming system according to claim 10, wherein, when the additional image is of a type to be combined on an entire surface of the sheet, the hardware processor does not execute the shift of the print coordinate of the additional image based on the correction of the document image on the back surface.

18. The image forming system according to claim 10, comprising a detector that reads the sheet on which an image has been formed to detect a defect, wherein
the hardware processor shifts the print coordinate of the additional image on the basis of the correction of the document image on the back surface, and uses the additional image after the shift of the print coordinate as a comparative image when the detector detects a defect.

19. A printing method executed in an image forming system including an image former that forms an image on a sheet conveyed through a conveyance path, the printing method comprising: a step (a) of acquiring information on an actual size of the sheet; and a step (b) of executing a first process on the basis of the actual size acquired in the step (a), the first process being controlled based on an end of the sheet separately from image formation based on a print job.
